(19) United States
(12) Patent Application Publication
(10) Pub. No.: US 2014/0130653 A1
(43) Pub. Date: May 15, 2014

(54) CAM OPERATED LIGATURE

(71) Applicant: Brent Laidler, Lafayette, IN (US)

(72) Inventor: Brent Laidler, Lafayette, IN (US)

(21) Appl. No.: 13/675,214

(22) Filed: Nov. 13, 2012

(51) Int. Cl. G10D 9/02

(52) U.S. Cl. 84/380 R

(57) ABSTRACT

A cam operated ligature for securing a reed to a mouthpiece of a musical instrument. The cam operated ligature may include a band, configured to fit around the mouthpiece, and a cam lock lever rotatably attached to the band. When in use, the cam lock lever may be in a closed position, which secures the reed to the mouthpiece.

### BACKGROUND OF THE INVENTION

The present invention relates to ligature and, more particularly, to a cam operated ligature for a mouthpiece.

Currently, a woodwind musical instrument requires a reed to be attached to the mouthpiece. A reed is a thin strip of material which vibrates to produce a sound on a musical instrument. The reeds of most woodwind instruments are made from Arundo donax (“Giant cane”) or synthetic material; tuned reeds (as in harmonicas and accordions) are made of metal or synthetics.

### SUMMARY OF THE INVENTION

Reeds may be attached to the mouthpiece using a traditional ligature including one or more screws. The traditional ligature can be slow to use and can create uneven pressure on the reed.

As can be seen, there is a need for a mouthpiece ligature that is easy to use, fast and secures the reed evenly and consistently.

In one aspect of the present invention, a cam operated ligature comprises: a band configured to fit around a mouthpiece of a musical instrument; and a cam lock lever rotatably attached to said band, wherein said cam lock lever is in an open position and a closed position.

In another aspect of the present invention, said band is configured to secure a reed to said musical instrument in said closed position.

In another aspect of the present invention, said band is configured to release a reed from said musical instrument in said open position.

In another aspect of the present invention, a hinge pin, wherein said cam lock lever is rotatably attached to said band by said hinge pin.

In another aspect of the present invention a musical instrument system, comprising: a musical instrument comprising a mouthpiece and a reed; and a cam operated ligature comprising: a band configured to fit around the mouthpiece of the musical instrument; a cam lock lever rotatably attached to said band, said cam lock lever having an open position and a closed position; and a hinge pin, wherein said cam lock lever is rotatably attached to said band by said hinge pin, wherein said band is configured to secure the reed to said musical instrument in said closed position and to release a reed from said musical instrument in said open position.

These and other features, aspects and advantages of the present invention will become better understood with reference to the following drawings, description and claims.

### BRIEF DESCRIPTION OF THE DRAWINGS

FIG. 1 is a perspective view of the cam operated ligature in use;

FIG. 2 is a perspective view illustrating the mouthpiece 26 and the reed 24 exploded out of the cam operated ligature;

FIG. 3 is an exploded perspective view of the cam operated ligature;

FIG. 4 is a top view illustrating the cam operated ligature in the locked position;

FIG. 5 is section view taken along line 5-5 in FIG. 4;

FIG. 6 is detailed section view similar to FIG. 5, with the cam lock 18 shown in the locked position;

FIG. 7 is multiple perspective views of the cam operated ligature; and

FIG. 8 is multiple perspective views of the cam operated ligature in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Broadly, an embodiment of the present invention provides a cam operated ligature for securing a reed to a mouthpiece of a musical instrument. The cam operated ligature may include a band, configured to fit around the mouthpiece, and a cam lock lever rotatably attached to the band. When in use, the cam lock lever may be in a closed position, which secures the reed to the mouthpiece.

The present invention may include a cam lock ligature that is fast and easy to use when attaching a reed to a woodwind instrument mouthpiece. Further, the cam lock ligature creates an equalized pressure between the reed and the mouthpiece. The equalized pressure gives the instrument a better sound. The cam lock ligature is easy to use and provides consistent pressure to the reed.

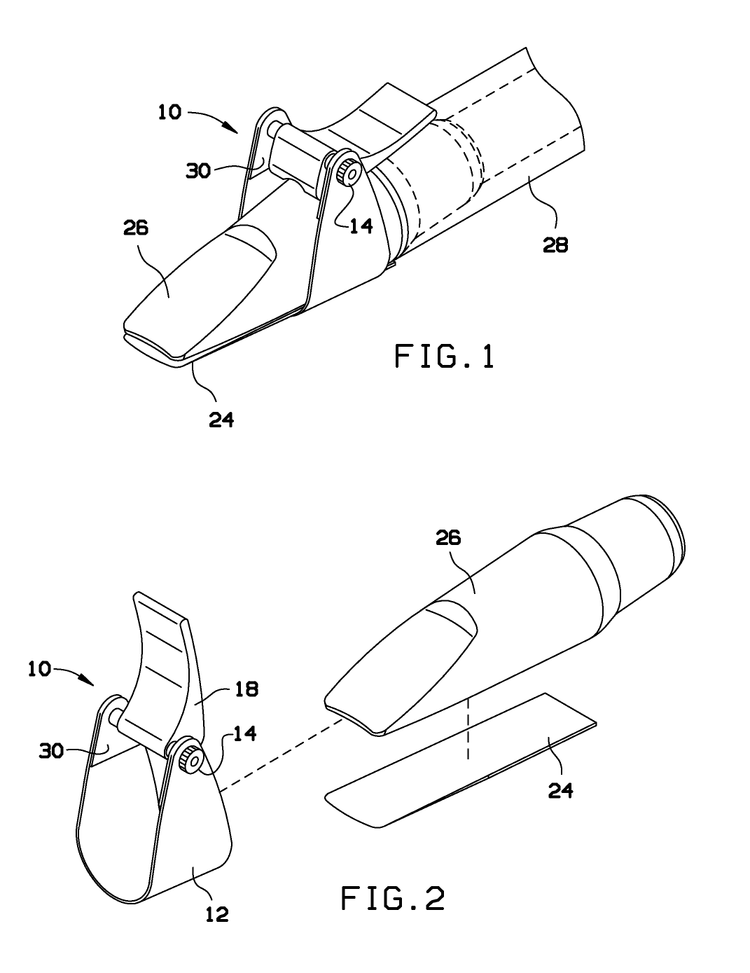

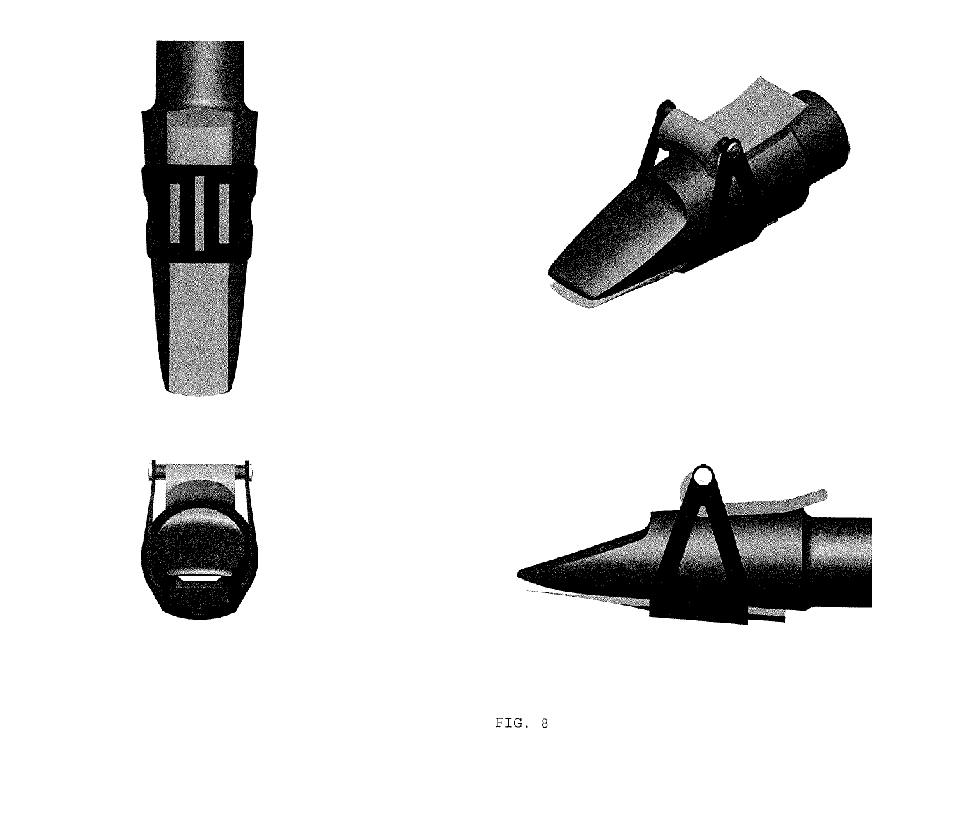

Referring to FIGS. 1 through 8, the device may comprise a cam operated ligature 10. The cam operated ligature 10 may include a band 12 and a cam lock lever 18. In certain embodiments, the band 12 is configured to fit or rap around a mouthpiece 26 of an instrument 28. The band may be made of leather, woven natural or synthetic fibers, polymers, metals and the like.

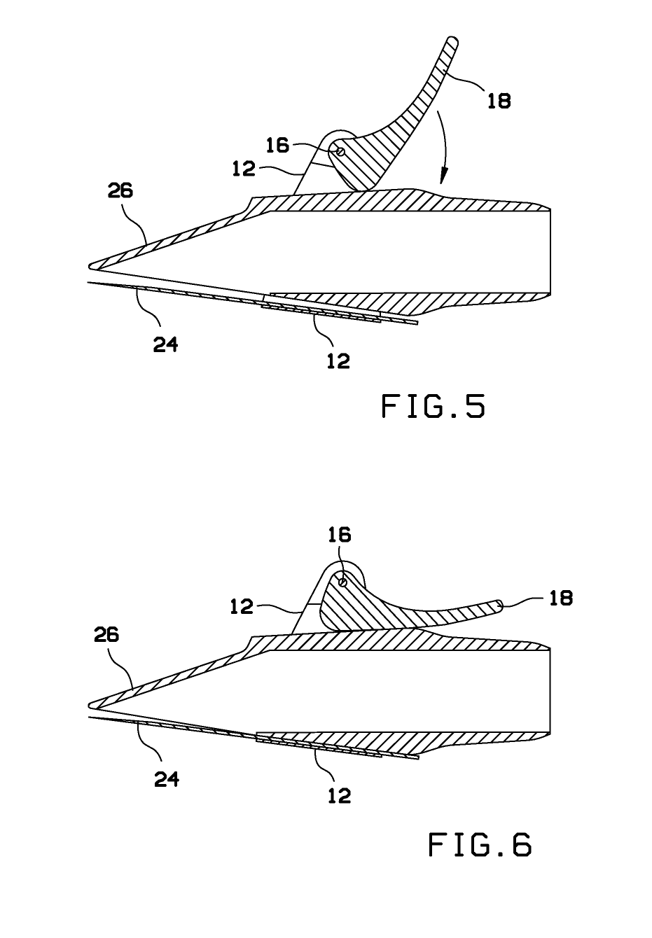

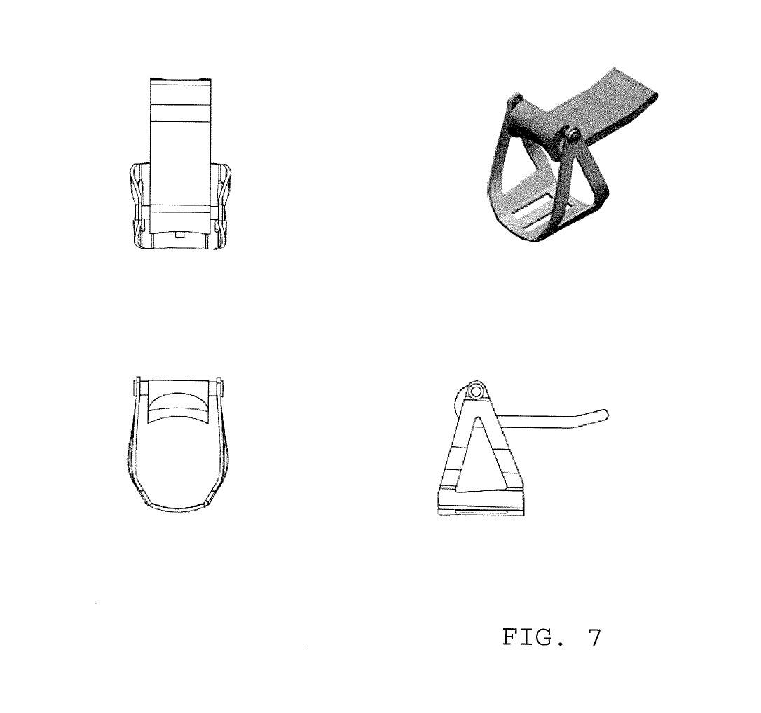

The cam lock lever 18 may rotatably attached to the band 12. As illustrated in FIGS. 5 and 6, the cam lock lever 18 may be rotated into an open position or a closed position. In certain embodiments, the band 12 may apply pressure to the mouthpiece 26 and hold a reed 24 securely against the mouthpiece 26 of the instrument 28 in a closed position. The band 12 may loosen and release the reed 24 from the mouthpiece 26 of the instrument in an opened position.

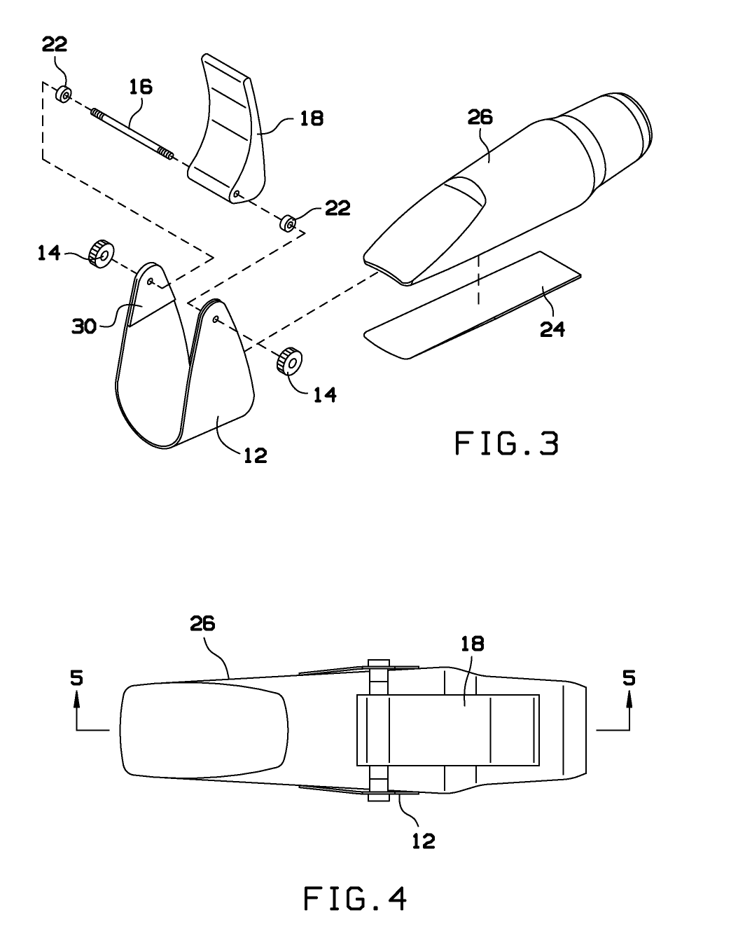

The cam lock lever 18 may be rotatably attached to the band 12 by any means. In certain embodiments, a hinge pin 16 may rotatably attach the cam lock lever 18 to the band 12. In such embodiments, the hinge pin 16 may fit through an opening in the cam lock lever 18 and an opening on either side of the band 12, as illustrated in FIG. 3. The opening in the cam lock lever 18 may be near the locking end of the cam lock lever 18. The hinge pin 16 may pass through a plurality of spacers 22. The plurality of spacer 22 may be located on either side of the cam lock lever 18 and in between the cam lock lever 18 and the band 12. In certain embodiments, the hinge pin may include threaded ends. In such embodiments, threaded holding nuts 14 may be screwed on either side of the hinge pin 16 and thereby secure the hinge pin 16 to the cam lock lever 18 and the band 12. In certain embodiments, there may be a reinforcement hold 30. The reinforcement hold 30 may be the band 12 folded over itself for reinforcement.

A method of making the present invention may include using a variety of materials for either the reed holding band or the cam lock lever that have a correct size and shape to fit each of the many different sizes and shapes of woodwind instrument mouthpieces. The hinge pin may be inserted through an opening in the locking end of the cam lock lever. The spacers go over the hinge pin on either side of the cam lock lever. Both threaded ends of the hinge pin may be inserted through an opening in each end of the band and are held in place with holding nuts.

A method of using the device may include the following. The device is placed over the end of the wood wind mouthpiece with the cam lock lever in the open (loose) position. The reed may be placed under the band in the correct and aligned place on the mouthpiece. The cam lock lever is flipped to the closed (tight) position and the reed may be held firmly in place. The instrument may now be ready for playing.

It should be understood, of course, that the foregoing relates to exemplary embodiments of the invention and that modifications may be made without departing from the spirit and scope of the invention as set forth in the following claims.

1. A cam operated ligature comprising:
a band comprising a first end and a second end, wherein said band is configured to fit around a mouthpiece of a musical instrument;
a cam lock lever comprising a cam lock portion and a lever portion, wherein an opening is formed through said cam lock portion; and
a hinge in attached to said first end and said second end, wherein said hinge pin runs through the opening formed through the cam lock portion, wherein the cam lock lever pivots relative to the hinge pin;
wherein said cam lock lever pivots to an open position and pivots to a closed position.

2. The cam operated ligature of claim 1, wherein said band is configured to secure a reed to said musical instrument in said closed position.

3. The cam operated ligature of claim 1, wherein said band is configured to release a reed from said musical instrument in said open position.

4. (canceled)

5. (canceled)

6. A cam operated ligature comprising:
a band comprising a first end and a second end, wherein said band is configured to fit around a mouthpiece of a musical instrument;
a cam lock lever comprising a cam lock portion and a lever portion wherein the cam lock portion and the lever portion are substantially oriented in between the first side and the second side, wherein the cam lock portion is pivotally connected to the first end and the second end of the band; and
wherein said cam lock lever pivots to an open position and pivots to a closed position.

7. A musical instrument system, comprising:
a musical instrument comprising a mouthpiece and a reed; and
a cam operated ligature comprising:
a band comprising a first end and a second end, wherein said band is configured to fit around the mouthpiece of a musical instrument;
a cam lock lever comprising a cam lock portion and a lever portion, wherein an opening is formed through said cam lock portion; and
a hinge pin attached to said first end and said second end, wherein said hinge pin runs through the opening formed through the cam lock portion, wherein the cam lock lever pivots relative to the hinge pin;
wherein said cam lock lever pivots to an open position and pivots to a closed position.
wherein said cam operated ligature secures the reed to said musical instrument in said closed position and releases the reed from said musical instrument in said open position.
